(19) United States
(12) Patent Application Publication
(10) Pub. No.: US 2006/0185094 A1
(43) Pub. Date: Aug. 24, 2006

(54) Condensates containing acid groups

(75) Inventors: Nils Brinkmann, Leverkusen (DE); Martin Kleban, Leverkusen (DE); Karl-Heinz Lammich, Koln (DE)

Correspondence Address: LANXESS CORPORATION, 111 RIDC PARK WEST DRIVE, PITTSBURGH, PA, 15275-1112, US

(73) Assignee: LANXESS Deutschland GmbH

(21) Appl. No.: 11/355,558

(22) Filed: Feb. 16, 2006

(30) Foreign Application Priority Data
Feb. 22, 2005 (DE) 10 2005 008 034.0

(51) Int. Cl. C14C 11/00

(52) U.S. Cl. 8/94.21

(57) ABSTRACT

Condensates containing acid groups and based on
a) at least one monoaldehyde from the group consisting of C₂-C₁₂-monoaldehydes and
b) at least one compound carrying an NH₂ group, acid group being understood as meaning sulpho and/or carboxyl groups and salts thereof.

The invention relates to aldehyde condensates containing acid groups and salts thereof, processes for the preparation thereof, their use as leather auxiliaries, in particular as tanning agents and retanning agents, and the leathers and furs tanned and retanned therewith.

The production of leather and furs from hides and skins takes place as a rule in a plurality of steps. After the preparatory steps of the beamhouse, such as unhairing, fleshing, deliming and bating, a typical sequence consists of tanning, retanning, dyeing, fatliquoring and finishing. The individual operations can be divided into further subunits.

While the tanning leads to an increase in the shrinkage temperature of the leather, the retanning has hardly any effect thereon. Retanning is understood as meaning the aftertreatment of pretanned, often chrome-tanned leather, in order to optimize colour, levelness, softness, fullness and the behaviour towards water (hydrophobicity) and to fix tanning agents. In particular, the tanning, retanning and dyeing are usually carried out in different so-called tanning drums with the use of aqueous tanning agent/retanning agent solutions or dispersions or dye solutions.

Condensates as retanning agents for leather have already been described, for example, in U.S. Pat. No. 3,063,781, EP-A-63319, DE-A-19823155, U.S. Pat. No. 4,656,059, WO94/10231, GB-A-2371559 and DE-A-4436182.

EP-A 063 319 describes a process for the preparation of water-soluble resin tanning agents from melamine, urea, formaldehyde and sodium bisulphite as a retanning agent for leather.

However, these condensates still have disadvantages for the leathers retanned therewith, in particular in the fullness, softness, grain break, handle, tight-grained character and dyeability.

Surprisingly, the condensates according to the invention have a substantially improved property spectrum; in particular improved softness, fullness, dyeability, tight-grain character and handle are found.

At the same time, the leathers treated with the condensate according to the invention are distinguished by freedom from formaldehyde according to DIN 53 315. An advantage which is also to be rated as being very positive.

Surprisingly, condensates containing acid groups and based on

a) at least one monoaldehyde from the group consisting of C₂-C₁₂-monoaldehydes and

b) at least one compound carrying an NH₂ group,

acid groups being understood as meaning sulpho and/or carboxyl groups and salts thereof, have now been found.

“Based on” means that the condensate is optionally prepared from further reactants in addition to a), b) and optionally c) and d) and reactants introducing acid groups.

The respective groups a) and b) are, however, definitive with regard to the monoaldehydes or compounds carrying NH₂ groups which are used. This means that no other monoaldehyde is used as a constituent if it does not satisfy the definition of a). For the sake of clarity, it should be mentioned that, for example, formaldehyde—since it is a C₁-monoaldehyde—is not suitable as a reactant for the condensates according to the invention. Preferred condensates according to the invention are composed of more than 95% by weight, in particular more than 99% by weight, of the components a), b), c), d) and reactants for introducing the acid groups.

Suitable monoaldehydes of component a) are both aliphatic and aromatic aldehydes. Aliphatic aldehydes, in particular C₂-C₇-monoaldehydes, are preferred. One or more compounds from the group consisting of acetaldehyde, acrolein, propionaldehyde, butyraldehyde, isobutyraldehyde, crotonaldehyde, pentanaldehyde, hexanaldehyde and heptanaldehyde, and isomers, are particularly preferably used as the monoaldehyde of component a).

Isobutyraldehyde is particularly preferred.

Suitable compounds of component b) which contain NH₂ groups are in particular primary amines and amides. These are preferably aliphatic or aromatic C₁-C₁₀-amines and/or C₁-C₁₀-amides. Cyanamide, urea, melamine, guanidine, formoguanamine, benzoguanamine, acetoguanamine, caprinoguanamine, isobutyroguanamine, acrylamide, benzamide, dicyandiamide (cyanoguanidine) or mixtures thereof are particularly preferably used.

Melamine is preferably used in combination with urea. The condensates according to the invention carry sulpho and/or carboxyl groups or salts thereof.

Preferred salts are alkali metal, alkaline earth metal or ammonium salts, particularly preferably in the form of their sodium or potassium salts.

Preferred acid groups are sulpho groups and their salts.

Suitable reactants for introducing the acid groups, in particular the sulpho groups, are, for example, concentrated sulphuric acid, oleum, chlorosulphonic acid, alkali metal, alkaline earth metal or ammonium disulphite, alkali metal, alkaline earth metal or ammonium bisulphite, alkali metal, alkaline earth metal or ammonium sulphamate or mixtures of these reactants.

For example, oxidations of alkyl groups, alkene groups, aldehyde groups or alcohol groups, the hydrolysis of amides, esters or acyl chlorides, the incorporation of compounds carrying carboxylic acid or the incorporation of ester-carrying or amide-carrying compounds carrying acyl chloride and the subsequent hydrolysis thereof are suitable for introducing carboxyl groups.

On introduction of the acid groups, in particular the OH groups generated from the reaction of the amines with the aldehydes are converted into acid groups, in particular into sulpho groups.

One or more dialdehydes are suitable as a further constituent of the condensate according to the invention, for example as component c). These are preferably aliphatic or aromatic C₂-C₁₂-dialdehydes, in particular aliphatic C₂-C₇-dialdehydes, such as glyoxal, malonaldehyde, butanedial, pentanedial, in particular glutardialdhyde, hexanedial and heptanedial, and all isomers thereof, and mixtures thereof. Glutardialdehyde is particularly preferred.

As a preferred component d) optionally to be concomitantly used, one or more aliphatic or aromatic alcohols are concomitantly used as further constituents. For example, methanol, ethanol, propanol, ethanediol, diethanolamine, glycerol, triethanolamine and phenol are preferred.

Ethanol, ethanediol, diethanolamine, glycerol, triethanolamine and phenol are particularly preferred.

The amount of acid groups is preferably from 10 to 90 mol %, based on the sum of the amount of monoaldehyde a) used and optionally used dialdehyde c).

It is preferable to use the components a) to c) in the following ratios:

a) from 2 to 95% by weight,

b) from 2 to 95% by weight and

c) from 0 to 95% by weight,

the percentages of a) to c) summing to 100%.

The compounds according to the invention preferably have an average molecular weight of from 300 to 50 000 g/mol, in particular from 1000 to 15 000 g/mol, and preferably have residue-free water solubility or water emulsifiability at 20° C. of more than 50 g/l.

The condensates can be used as solids, for example as powders or granules, or as aqueous solutions or dispersions.

The invention furthermore relates to a process for the preparation of the compounds according to the invention, characterized in that the components a) and b) and optionally a further component are condensed and the reaction with reactants introducing acid groups is effected before, during or after the condensation.

The condensation can be effected, for example, with the use of basic or acidic catalysts or completely without catalysts.

The condensation reaction can be effected in aqueous solution at temperatures of from 20° C. to 200° C. in a basic or acidic medium. The sequence of addition of the reactants and the reaction procedure do of course influence the properties of the resulting product, such as, for example, the molecular weight.

The introduction of sulpho groups can be effected before, during or after the condensation, for example by

1) reaction with concentrated sulphuric acid or

2) reaction with oleum or

3) reaction with chlorosulphonic acid or

4) reaction with alkali metal, alkaline earth metal or ammonium disulphites or

5) reaction with alkali metal, alkaline earth metal or ammonium bisulphites or

6) reaction with alkali metal, alkaline earth metal or ammonium sulphamates or

a mixture of the above possibilities 1) to 6) for sulphonation.

In a preferred embodiment, the introduction of sulpho groups is effected by reaction with sodium disulphite, in a manner such that sodium disulphite is reacted with a part of the aldeyhyde components a) and optionally c) and the amine or amide component b) in an aqueous medium at temperatures of from 20 to 200° C., preferably at from 20 to 150° C., particularly preferably beginning at 20-50° C. and ending at from 70 to 140° C. After the reaction, a reaction is preferably carried out with further aldehyde components (a) and optionally (c) at temperatures of from 20 to 200° C., preferably at from 60 to 200° C., particularly preferably at from 70 to 140° C.

The invention furthermore relates to the use of the compounds according to the invention, and mixtures containing the compounds according to the invention, for the tanning of hides or skins and for the retanning of mineral tanned leathers, in particular chrome-tanned leather, characterized in that the hides or skins or the tanned leather are treated with the condensate according to the invention in aqueous liquor.

The invention also relates to leathers or furs which are tanned or retanned with the compounds according to the invention.

The use of tanning agents/retanning agents is known to the person skilled in the art and is also described, inter alia, in Herfeld (Editor) “Bibliothek des Leders” [Leather Library], Vol. 3, 306-314, examples 10-16, Umschau-Verlag.

In a preferred use, the leathers or furs according to the invention are produced by adjusting commercial wet blue to a pH of from 4.0 to 6.5, preferably from 4.8 to 5.5, in a commercial tanning apparatus, such as a tanning drum, mixer or Dosamat, and then retanning it in aqueous liquor with 3-20% of the retanning agent according to the invention, alone or in combination with further retanning agents/dyes/fatliquoring agents. The leather thus treated can be further processed in a manner customary in the industry.

Leathers which are tanned or retanned with the substance according to the invention have a particular fullness in addition to softness. Moreover, the substance according to the invention leads to improved dyeability.

The substance according to the invention can of course also be used in combination with further additives. Suitable such additives are, for example, neutralizing agents, buffers, dispersants, antifoams, fats, water repellents, dyeing auxiliaries or other tanning agents/retanning agents.

The invention furthermore relates to the use of the substance according to the invention as an auxiliary for paper or textile applications.

In the context of this invention, all combinations of the above-disclosed general ranges and of the preferred ranges, and of the preferred ranges with one another, are also considered to be disclosed preferred ranges.

### EXAMPLES

### Example 1

540 g of water were initially introduced at RT, and 184 g of isobutyraldehyde (2.55 mol) were added. 375 g of sodium disulphite were then introduced in portions, the temperature increasing to 68° C. After addition of 120 g of melamine, stirring was effected for a further 15 min at 50° C. After heating to 95° C., 187 g of isobutyraldehyde (2.59 mol) were added in the course of two hours. After addition of 5 g of methanesulphonic acid, stirring was effected for 12 hours at 95° C. (exothermic reaction). Evaporation to dryness was effected in a rotary evaporator and drying was carried out at 100° C.

### Example 2

800 g of water were initially introduced at room temperature, and 399.2 g of sodium disulphite were added. 97.4 g of isobutyraldehyde (1.05 mol) were added, beginning at 30° C. The temperature increased to 55° C. during this procedure. After addition of 94.6 g of melamine and 22.5 g of urea, heating was effected to 95° C. and 410.0 g of aqueous, 50% strength by weight glutardialdehyde solution (2.05 mol) were added in the course of 30 minutes. At 94-98° C., stirring was effected for a further 10 h. Evaporation to dryness was effected and drying was carried out at 100° C.

### Example 3

840 g of water were initially introduced at room temperature, and 399.2 g of sodium disulphite were added. 194.7 g of isobutyraldehyde (2.7 mol) were added, beginning at 30° C. The temperature increased to 64° C. during this procedure. After addition of 126.1 g of melamine (1 mol) and 62.1 g of ethanediol (1 mol), stirring was effected for a further 15 minutes at 55° C. Heating to 95° C. was effected and 197.6 g of isobutyraldehyde (2.74 mol) and 10 g of methanesulphonic acid were added in the course of 30 minutes. At 95-98° C., stirring was effected for a further 6 h. Evaporation to dryness was effected in a rotary evaporator and drying was carried out at 100° C.

### Example 4

840 g of water were initially introduced at room temperature, and 399.2 g of sodium disulphite were added. 194.7 g of isobutyraldehyde (2.7 mol) were added, beginning at 30° C. The temperature increased to 65° C. during this procedure. After addition of 126.1 g of melamine (1 mol) and 94.1 g of phenol (1 mol), stirring was effected for a further 15 minutes at 65° C. Heating to 95° C. was effected and 197.6 g of isobutyraldehyde (2.74 mol) and 10 g of methanesulphonic acid were added in the course of 30 minutes. At 95-98° C., stirring was effected for a further 6 h. Evaporation to dryness was effected in a rotary evaporator and drying was carried out at 100° C. The product was finally mixed with 20 percent by weight of ligninsulphonate, 10 percent by weight of a water-soluble naphthalenesulphonic acid/formaldehyde condensate based on 128 parts of naphthalene and 20 parts of formaldehyde, and 30 percent by weight of sodium sulphate (based in each case on product after drying in the rotary evaporator) in a dry blender.

### Example 5

400 g of water were initially introduced at room temperature and 375 g of sodium disulphite were added. 74.9 g of acetaldehyde (1.7 mol), dissolved in 100 g of water, were added, beginning at 30° C. The temperature increased to 68° C. during this procedure. After addition of 120 g of melamine, stirring was effected for a further 15 minutes at 70° C. Heating to 95° C. was effected and 76 g of acetaldehyde (1.725 mol), dissolved in 100 g of water, were added in the course of 30 minutes. After one hour at 98° C., a clear solution resulted. At 95-98° C., stirring was effected for a further 3 hours. The mixture was converted into a solid by spray drying.

### Example 6

375 g of water were initially introduced at room temperature, and 375 g of sodium disulphite were added. 98.7 g of propionaldehyde (1.7 mol), dissolved in 100 g of water, were added in the course of 30 minutes, beginning at 30° C. The temperature increased to 54° C. during this procedure. After addition of 120 g of melamine, stirring was effected for a further 15 minutes at 55° C. Heating to 95° C. was effected and 100.2 g of propionaldehyde (1.725 mol), dissolved in 100 g of water, were added in the course of 60 minutes. After 1.5 hours at 95-98° C., a clear solution resulted. Evaporation to dryness was effected in a rotary evaporator and drying was carried out at 100° C.

### Example 7

840 g of water were initially introduced at room temperature, and 399 g of sodium disulphite (2.1 mol) were added. 194.7 g of isobutyraldehyde (2.7 mol) were added in the course of 30 minutes, beginning at 30° C. The temperature increased to 65° C. during this procedure. After addition of 126.1 g of melamine (1 mol) and 94.1 g of phenol (1 mol), stirring was effected for a further 15 minutes at 65° C. Heating to 95° C. was effected and 197.6 g of isobutyraldehyde (2.74 mol) and 10 g of methanesulphonic acid were added in the course of 30 minutes. After 10 hours at 95-98° C., a clear solution resulted. 475.9 g of sodium sulphate, dissolved in 800 g of water, were added in the course of 15 minutes. Evaporation to dryness was effected in a rotary evaporator and drying was carried out in vacuo at 100° C.

### Example 8

800 g of water were initially introduced at room temperature, and 399 g of sodium disulphite (2.1 mol) were added. 195 g of isobutyraldehyde (2.7 mol) were added in the course of 30 minutes, beginning at 30° C. The temperature increased to 55° C. during this procedure. After addition of 126.1 g of melamine (1 mol), heating to 95° C. was effected and 199 g of aqueous, 40% strength by weight glyoxal solution (1.37 mol) were added in the course of 30 minutes. Stirring was effected for a further 6 h at 94-98° C. After addition of 5 g of methanesulphonic acid, stirring was effected for a further 6 h at 94-98° C. 475.9 g of sodium sulphate, dissolved in 500 g of water, were added in the course of 15 minutes. Evaporation to dryness was effected in a rotary evaporator and drying was carried out in vacuo at 100° C.

### Comparative Example 1

### Comparative Product from EP-A-063319 (Example 1)

92 parts of a 65% strength aqueous solution of a condensate of 34 parts of urea, 30 parts of formaldehyde and 15 parts of melamine (viscosity: 85 sec, 4 mm Ford cup at 20° C.) are stirred into 50 parts of water with 52 parts of sodium bisulphite and 30 parts of urea for 2 h at 90° C. Thereafter, 50 parts of 30% strength formaldehyde solution are added dropwise, dilution is effected with 40 parts of water and stirring is effected for 5 h at 90° C.

### Comparative Example 2

### Commercial Resin Tanning Agent

680 parts of formalin (30% strength) are diluted with 96 parts of water, and 100 parts of sodium disulphite are added at 50° C. 32 parts of melamine are added, stirring is effected for 15 min and heating is effected with 69 parts of formalin to 95° C. After stirring for 2 h at 95° C., dilution is effected with 400 parts of water, 120 parts of sodium sulphate are added and the mixture is converted into a solid by spray drying.

### Use Example 1

### Model Formulation for Retanning

Wet blue (cattle, 100 g) is agitated in a drum with 100% of water (stated percentages always based on the wet blue weight), 1% of sodium formate and 0.8% of sodium bicarbonate overnight at 40° C. After discharge of the liquor and washing, agitation is effected in the drum with 100% of water and 5% of the tanning agent according to example 1 (the stated percentages are based on the solids content) at 40° C. for 2 hours. Finally, the leathers are agitated with 300% of water, 0.5% of dye and 10% of a commercial fat mixture for 90 minutes at 50° C. in the drum. After addition of 2.5% of formic acid (85% strength) and further treatment in the drum for 15 minutes, washing, setting out and hanging to dry were carried out.

A leather which is substantially superior in softness and fullness to that obtained with the comparative products from comparative examples 1 and 2 is obtained. The leather is moreover substantially more intensely dyed than comparable leathers which were treated with comparative example 2.

The leathers obtained were investigated according to the test method DIN 53315 “Detection of free formaldehyde in leather”. 241 ppm of formaldehyde were present in the leather produced using comparative product 1, and 146 ppm with comparative product 2. In the leather produced using the product according to the invention, no formaldehyde was detectable.

### Use Example 2

### Retanning for Furniture Leather

Raw materials: Wet blue, cattle, shaved thickness 1.2 mm, weight 6.8 kg. Stated amounts are based on shaved weight.

| | | | | | Time | |
|---|---|---|---|---|---|---|
| | | % | Product | | min | Remark |
| Washing | | 200 | Water 40° C. | | | |
| | | 0.2 | Formic acid 85% | 1:10 | 15 | pH 3.6 |
| | | | | | | Liquor discharged |
| Neutralization | | 100 | Water 35° C. | | | |
| | | 3.0 | Chrome syntan | | | |
| | | 2.0 | Neutralization tanning agent | | 15 | |
| | + | 1.3 | Sodium bicarbonate | | 90 | pH 5.7 |
| | | | | | | Liquor discharged |
| Washing | | 200 | Water 35° C. | | 10 | |
| | | | | | | Liquor discharged |
| Dyeing | | 50 | Water 35° C. | | | |
| | | 4.0 | Product from example 2 | | | |
| | | 2.0 | Red dye | | | |
| | | 3.0 | Dark brown dye | | 60 | Penetration test |
| | + | 50 | Water 60° C. | | 5 | |
| Retanning/ | + | 14.0 | Fatliquoring agent | 1:2 | 60 | |
| Fatliquoring | + | 50 | Water 60° C. | | 5 | |
| | + | 1.5 | Formic acid 85% | 1:10 | 30 | pH 3.8 |
| | | | | | | Liquor discharged |
| Top dyeing | | 100 | Water 50° C. | | | |
| | | 0.7 | Red dye | | | |
| | | 0.3 | Dark brown dye | 1:20 | 20 | |
| | + | 1.0 | Formic acid | | 20 | |
| | | | | | | Liquor discharged |
| Washing | | 200 | Water 20° C. | | 10 | |
| | | | | | | Liquor discharged |

Leather on horse, set out, stretch while wet, conditione, stake, mill overnight.

The Bordeaux-coloured leather obtained is distinguished by a particular softness and a uniform milled appearance. The loose-grained, empty areas on neck and flanks are substantially smaller than in the case of a leather produced analogously without the product according to the invention. In a controlled measurement according to DIN 53315, no formaldehyde was detectable.

### Use Example 3

### Retanning for Upper Leather

Raw material: Wet blue, cattle, shaved thickness 1.8 mm; stated amounts based on shaved weight.

| | | | Time | |
|---|---|---|---|---|
| % | Product | | min | Remarks |
| 200 | Water 40° C. | | | |
| 0.2 | Formic acid | 1:10 | 10 | pH: 3.5 |
| | | | | Discharge |
| 100 | Water 40° C. | | | |
| 2.0 | Neutralization tanning agent | | | |
| 1.0 | Sodium formate | | | |
| 0.8 | Sodium bicarbonate | | | |
| 3.0 | Synthetic tanning agent | | 30 | pH: 5.3 |
| 2.0 | Water-repellent fatliquoring agent | | | |
| 1.0 | Silicone polymer | 1:4 | 90 | pH: 4.8 |
| | | | | Discharge |
| 200 | Water 30° C. | | 10 | Discharge |
| 50 | Water 30° C. | | | |
| 4.0 | Polyacrylate retanning agent | 1:4 | 30 | |
| 4.0 | Synthetic tanning agent | | | |
| 3.0 | Chestnut tanning agent | | | |
| 6.0 | Product according to example 4 | | | |
| 1.5 | Brown dye | | 30 | |
| 0.5 | Ammonium bicarbonate | | 10 | |
| 5.0 | Water-repellent fatliquoring agent | 1:3 | | |
| 3.5 | Silicone polymer | 1:3 | 90 | |
| 100 | Water 50° C. | | 5 | |
| 1.5 | Formic acid | 1:10 | 15 | |
| 1.5 | Formic acid | 1:10 | 45 | pH: 3.5 |
| | | | | Discharge |
| 250 | Water 50° C. | | | |
| 0.3 | Brown dye | | | |
| 1.0 | Formic acid | 1:10 | 30 | pH: 3.5 |
| | | | | Discharge |
| 50 | Water 50° C. | | | |
| 2.0 | Chrome tanning agent 33% basic | | 60 | pH: 3.2 |
| | | | | Discharge |
| 300 | Water 50° C. | | 10 | Discharge |

Leather on horse, setting out, vacuum drying for 2 min at 60° C., hanging to dry, staking, vacuum drying for 30 sec at 60° C.

The leather obtained is distinguished by particular fullness and a dry handle. It is substantially more tight-grained than a leather produced analogously without the product according to the invention or with the product from comparative example 2. In a controlled measurement according to DIN 53315, no formaldehyde was detectable.

The following examples of table 1 were carried out analogously to examples 2, 3, 7 and 8.

The following examples of table 1 were carried out analogously to examples 2, 3, 7 and 8.

TABLE 1
Data in percentages by weight without taking into account water and added sodium sulphate*:

| | Example | | | | | | | | | | | | | | | | | | | | | |
|---|---|---|---|---|---|---|---|---|---|---|---|---|---|---|---|---|---|---|---|---|---|---|
| | 9 | 10 | 11 | 12 | 13 | 14 | 15 | 16 | 17 | 18 | 19 | 20 | 21 | 22 | 23 | 24 | 25 | 26 | 27 | 28 | 29 | 30 |
| Sodium disulphite | 43 | 13 | 22 | 37 | 48 | 32 | 43 | 48 | 45 | 41 | 44 | 39 | 39 | 40 | 37 | 35 | 50 | 39 | 39 | 39 | 39 | 39 |
| Component a) | | | | | | | | | | | | | | | | | | | | | | |
| Isobutyraldehyde | 43 | 15 | 23 | 37 | 48 | 57 | 42 | 36 | 40 | 45 | 43 | 38 | 39 | 40 | 36 | 35 | 37 | 48 | | | | |
| Acetaldehyde | | | | | | | | | | | | | | | | | | | 48 | | | |
| Acrolein | | | | | | | | | | | | | | | | | | | | 48 | | |
| Crotonaldehyde | | | | | | | | | | | | | | | | | | | | | 47 | |
| n-Hexanaldehyde | | | | | | | | | | | | | | | | | | | | | | 38 |
| Component b) | | | | | | | | | | | | | | | | | | | | | | |
| Melamine | 14 | 70 | 55 | 26 | 4 | 11 | 14 | 15 | 14 | 13 | 7 | 12 | 12 | 13 | 12 | 11 | 12 | 12 | 12 | 12 | 13 | 22 |
| Urea | | | | | | | | | | 5 | | | | | | | | | | | | |
| Component d) | | | | | | | | | | | | | | | | | | | | | | |
| Diethanolamine | | | | | | | | | | | | 10 | | | | | | | | | | |
| Glycerol | | | | | | | | | | | | | 9 | | | | | | | | | |
| Ethanediol | | | | | | | | | | | | | | 6 | | | | | | | | |
| Triethanolamine | | | | | | | | | | | | | | | 14 | | | | | | | |
| Preparation | Ex. 2 | | | | | | | | | | | Ex. 3 | | | | Ex. 2 | | | | | | |
| analogous to: | | | | | | | | | | | | | | | | | | | | | | |
| Catalyst: | | | | | | | | | | | | | | | | | | | | | | |
| Methanesulphonic | | | | | | | 1 | 1 | 1 | 1 | 1 | 1 | 1 | 1 | 1 | 1 | 1 | 1 | 1 | 1 | 1 | 1 |
| acid | | | | | | | | | | | | | | | | | | | | | | |
| Further additives: | | | | | | | | | | | | | | | | | | | | | | |
| Ligninsulphonate | | | | | | | | | | | | | | | | 18 | | | | | | |

TABLE 2
Data in percentages by weight without taking into
account water and added sodium sulphate*:

| | Example | | | | | | | | | |
|---|---|---|---|---|---|---|---|---|---|---|
| | 31 | 32 | 33 | 34 | 35 | 36 | 37 | 38 | 39 | 40 |
| Sodium disulphite | 44 | 38 | 31 | 23 | 14 | 37 | 37 | 37 | 39 | 38 |
| Component a) | | | | | | | | | | |
| Isobutyraldehyde | 44 | 39 | 31 | 23 | 9 | 35 | 35 | 31 | 39 | 30 |
| Component b) | | | | | | | | | | |
| Melamine | 6 | 12 | 19 | 27 | 36 | 13 | 13 | 12 | 12 | 12 |
| Component c) | | | | | | | | | | |
| Glutardialdehyde | 5 | 10 | 18 | 26 | 40 | 14 | | 19 | | 10 |
| Glyoxal | | | | | | | | | | |
| Malonaldehyde | | | | | | | 14 | | | |
| Component d) | | | | | | | | | | |
| Phenol | | | | | | | | | 9 | 9 |
| Preparation | Ex. 7 | | | | | | | | | |
| analogous to: | | | | | | | | | | |
| Catalyst: | | | | | | | | | | |
| Methanesulphonic | 1 | 1 | 1 | 1 | 1 | 1 | 1 | 1 | 1 | 1 |
| acid | | | | | | | | | | |

TABLE 3
Data in percentages by weight without taking into account water and added sodium sulphate*:

| | Example | | | | | | | | | | | | | | | | | |
|---|---|---|---|---|---|---|---|---|---|---|---|---|---|---|---|---|---|---|
| | 41 | 42 | 43 | 44 | 45 | 46 | 47 | 48 | 49 | 50 | 51 | 52 | 53 | 54 | 55 | 56 | 57 | 58 |
| Sodium disulphite | 39 | 41 | 37 | 35 | 40 | 41 | 41 | 41 | 38 | 39 | 39 | 43 | 35 | 36 | 43 | 44 | 58 | 54 |
| Component a) | | | | | | | | | | | | | | | | | | |
| Propionaldehyde | | | | | | | | | | | | | | | | | | 29 |
| Isobutyraldehyde | 46 | 44 | 36 | 35 | 19 | 20 | 20 | 20 | 9 | 9 | 9 | 21 | 17 | 17 | 21 | 21 | | |
| Acetaldehyde | | | | | | | | | | | | | | | | | 23 | |
| Component b) | | | | | | | | | | | | | | | | | | |
| Melamine | 14 | 14 | 12 | 11 | 13 | 10 | 6 | 10 | 13 | 9 | | 14 | 11 | 8 | 10 | 7 | 19 | 17 |
| Urea | | | | | | 2 | 5 | 2 | | 2 | 2 | | | 2 | 2 | 5 | | |
| Dicyandiamide | | | | | | | | | | | 9 | | | | | | | |
| Component c) | | | | | | | | | | | | | | | | | | |
| Glutardialdehyde | | | | | 27 | 27 | 28 | 27 | 39 | 40 | 40 | | | | | | | |
| Glyoxal | | | | | | | | | | | | 21 | 36 | 36 | 23 | 22 | | |

| | | | | |
|---|---|---|---|---|
| Preparation | Ex. 2 | Ex. 8 | Ex. 2 | Ex. 2 |
| analogous to: | | | | |

| Catalyst: | | | | | | | | | | | | | |
|---|---|---|---|---|---|---|---|---|---|---|---|---|---|
| Methanesulphonic | 1 | 1 | 1 | 1 | 1 | 1 | 1 | 1 | 1 | 1 | 1 | 1 | 1 |
| acid | | | | | | | | | | | | | |
| Further additives: | | | | | | | | | | | | | |
| Ligninsulphonate | | | 14 | 18 | | | | | | | | | |
| *The experiments were carried out in an aqueous medium; further information in this context is to be found in examples 1 to 8, see above. Furthermore, some of the experiments were carried out in a manner such that sodium sulphate was added after the end of the reaction, cf. examples 7 and 8. The examples in the tables were carried out correspondingly. The condensates according to the invention can be used both as aqueous solution and after drying, possibly spray | | | | | | | | | | | | | |
| # drying. Prior to drying, they can be mixed with auxiliaries, such as, for example, neutral salts, neutralizing agents, buffers, dispersants, antifoams, fats, water repellents, dyeing auxiliaries or other tanning agents/retanning agents. | | | | | | | | | | | | | |

1. Condensates containing acid groups and based on
a) at least one monoaldehyde from the group consisting of C₂-C₁₂-monoaldehydes and
b) at least one compound carrying an NH₂ group,
acid group being understood as meaning sulpho and/or carboxyl groups and salts thereof.

2. Condensates according to claim 1, wherein aliphatic monoaldehydes are used as monoaldehydes of component a).

3. Condensates according to claim 1, wherein C₂-C₇-monoaldehydes are used as monoaldehydes of component a).

4. Condensates according to claim 1, wherein one or more compounds from the group consisting of acetaldehyde, acrolein, propionaldehyde, butyraldehyde, isobutyraldehyde, crotonaldehyde, pentanaldehyde, hexanaldehyde, heptanaldehyde and isomers thereof, in particular isobutyraldehyde, are used as monoaldehydes of component a).

5. Condensates according to claim 1, wherein primary amines and/or amides, in particular aliphatic or aromatic C₁-C₁₀-amines and/or amides, in particular cyanamide, urea, melamine, guanidine, formoguanamine, benzoguanamine, acetoguanamine, caprinoguanamine, isobutyroguanamine, acrylamide, benzaldehyde, dicyandiamide (cyanoguanidine) or mixtures thereof are used as compounds of component b) which contain NH₂ groups.

6. Condensates according to claim 1, wherein alkali metal, alkaline earth metal or ammonium salts are suitable as salts of the acid groups.

7. Condensates according to claim 1, wherein of one or more dialdehydes, are used as a further constituent of component c).

8. Condensates according to claim 1, wherein of one or more aliphatic or aromatic dialdehydes are used as a further constituent of component c).

9. Condensates according to claim 1, wherein of one or C₂-C₁₂-dialdehydes are used as a further constituent of component c).

10. Condensates according to claim 1, wherein the one more compounds from the group consisting of glyoxal, malonaldehyde, butanedial, pentanedial, hexanedial and heptanedial, and all isomers thereof are used as a further constituent of component c).

11. Condensates according to claim 1, wherein as a further constituent, one or more aromatic or aliphatic alcohols are used as component d).

12. Condensates according to claim 1, wherein, as a further constituent, one or more compounds from the group consisting of methanol, ethanol, propanol, ethanediol, diethanolamine, glycerol, triethanolamine and phenol are used as component d).

13. A Process for the preparation of condensates according to claim 1, wherein the components a) and b) and optionally further components are condensed and the reaction with reactants introducing acid groups is effected before, during or after the condensation.

14. A process for tanning hides or skins or for retanning mineral tanned leather in aqueous liquor wherein condensates according to claim 1 are used.

15. Leathers or furs tanned or retanned with at least one condensate according to claim 1.

16. A Porocess for applying the condensates according to claim 1 as auxiliaries for paper or textile applications.
